(19) United States
(12) Patent Application Publication
(10) Pub. No.: US 2026/0109082 A1
(43) Pub. Date: Apr. 23, 2026

(54) METHOD OF MANUFACTURING WAFER CLEANING BRUSH

(71) Applicant: Samsung Electronics Co., Ltd., Suwon-si (KR)

(72) Inventors: Dongchan Kim, Suwon-si (KR); Sanha Kim, Daejeon (KR); Somin Shin, Daejeon (KR); Byoungho Kwon, Suwon-si (KR)

(73) Assignees: Samsung Electronics Co., Ltd., Suwon-si (KR); KOREA ADVANCED INSTITUTE OF SCIENCE AND TECHNOLOGY, Daejeon (KR)

(21) Appl. No.: 19/315,945

(22) Filed: Sep. 2, 2025

(30) Foreign Application Priority Data
Oct. 21, 2024 (KR) 10-2024-0144350
Feb. 26, 2025 (KR) 10-2025-0025359

(51) Int. Cl. B29B 7/00; B29C 71/00; B29K 27/00; B29K 29/00; B29L 31/42; C08J 3/00

(52) U.S. Cl. CPC B29B 7/002; B29C 71/0009; C08J 3/005; B29K 2027/14; B29K 2029/04; B29L 2031/42

(57) ABSTRACT

Provided is a method of manufacturing a brush, such as a wafer cleaning brush. The method includes providing a polyvinyl alcohol (PVA) solution, forming an insoluble polyvinyl fluoride (PVF) by adding formaldehyde to the PVA solution, adding a water-soluble inorganic compound including a plurality of particles to the insoluble PVF, and mixing the insoluble PVF with the water-soluble inorganic compound to form a mixture of the water-soluble inorganic compound and the insoluble PVF, forming a brush by inserting the mixture of the water-soluble inorganic compound and the insoluble PVF into a mold and heat-treating the mixture, removing the wafer cleaning brush from the mold; and washing the wafer cleaning brush to remove the plurality of particles of the water-soluble inorganic compound from the wafer cleaning brush.

### CROSS-REFERENCE TO RELATED APPLICATION

This application is based on and claims priority under 35 U.S.C. § 119 to Korean Patent Application Nos. 10-2024-0144350, filed on Oct. 21, 2024, and 10-2025-0025359, filed on Feb. 26, 2025, in the Korean Intellectual Property Office, the disclosures of which are incorporated by reference herein in their entireties.

### BACKGROUND

The inventive concept relates to a method of manufacturing a brush, such as a wafer cleaning brush, and more particularly, to a method of manufacturing a brush using a water-soluble inorganic compound.

Semiconductor devices are formed by sequentially depositing conductors, semiconductors, or insulators on a wafer. After each layer is deposited, each layer is etched to impart device properties. Steps generated on the wafer surface after a photolithography process and an etching process are performed to sequentially deposit a series of layers must be removed, and a chemical mechanical polishing (CMP) process is used to planarize the wafer. After this CMP process, particles, such as polishing byproducts and slurries, remain on the wafer surface. Therefore, a cleaning process is performed on the wafer surface to remove particles, such as polishing byproducts and slurries. The cleaning process may be performed using a wafer cleaning brush. For the cleaning process to be performed efficiently, a wafer cleaning brush having fine and uniformly sized pores is desirable.

### SUMMARY

Aspects provided herein include a method of manufacturing a brush, such as a wafer cleaning brush, having fine and relatively uniform pores.

A method of manufacturing a wafer cleaning brush, is provided the method including providing a polyvinyl alcohol (PVA) solution, forming an insoluble polyvinyl fluoride (PVF) by adding formaldehyde to the PVA solution, adding a water-soluble inorganic compound comprising a plurality of particles to the insoluble PVF, and mixing the insoluble PVF with the water-soluble inorganic compound to form a mixture of the water-soluble inorganic compound and the insoluble PVF, forming a wafer cleaning brush by inserting the mixture of the water-soluble inorganic compound and the insoluble PVF into a mold and heat-treating the mixture, removing the wafer cleaning brush from the mold, and washing the wafer cleaning brush to remove the plurality of particles of the water-soluble inorganic compound from the wafer cleaning brush.

A method of manufacturing a wafer cleaning brush, is provided, the method including providing a PVA solution, adding a water-soluble inorganic compound comprising a plurality of particles and an acetone-based material to the PVA solution, and mixing the PVA solution, the water-soluble inorganic compound, and the acetone-based material to form a mixture of the PVA solution, the water-soluble inorganic compound, and the acetone-based material, adding formaldehyde to the mixture of the PVA solution, the water-soluble inorganic compound, and the acetone-based material to form an insoluble PVF and to form a mixture of the water-soluble inorganic compound, the acetone-based material and the insoluble PVF, forming a wafer cleaning brush by inserting the mixture of the water-soluble inorganic compound, the acetone-based material, and the insoluble PVF into a mold, and heat-treating the mixture, removing the wafer cleaning brush from the mold, and washing the wafer cleaning brush to remove the plurality of particles of the water-soluble inorganic compound from the wafer cleaning brush.

A method of manufacturing a wafer cleaning brush, is provided the method including providing a PVA solution, forming an insoluble PVF by adding formaldehyde and a catalyst to the PVA solution and crosslinking the PVA solution with the formaldehyde by the catalyst, adding a water-soluble inorganic compound comprising a plurality of particles to the insoluble PVF and mixing the insoluble PVF with the water-soluble inorganic compound to disperse the water-soluble inorganic compound in the insoluble PVF, forming a wafer cleaning brush by inserting a mixture of the water-soluble inorganic compound and the insoluble PVF into a mold and heat-treating the mixture, removing the wafer cleaning brush from the mold, and forming a plurality of pores by washing the wafer cleaning brush to remove the plurality of particles of the water-soluble inorganic compound from the wafer cleaning brush.

Brushes, or wafer cleaning brushes, are also provided that are made by any of the present methods.

### BRIEF DESCRIPTION OF THE DRAWINGS

Embodiments will be more clearly understood from the following detailed description taken in conjunction with the accompanying drawings in which:

FIG. 1 is an enlarged view of a portion of a wafer cleaning brush according to embodiments;

FIG. 2 is a flowchart of a method of manufacturing a wafer cleaning brush, according to embodiments;

FIG. 3 is a flowchart of a method of manufacturing a wafer cleaning brush, according to other embodiments;

FIG. 4 is a flowchart of a method of manufacturing a wafer cleaning brush, according to other embodiments; and

FIG. 5A includes images showing residual amounts of TSO-12 particles before and after a cleaning process using the wafer cleaning brush according to embodiments is performed, and FIG. 5B includes images showing residual amounts of COMPOL 80 particles before and after the cleaning process using the wafer cleaning brush is performed according to embodiments.

### DETAILED DESCRIPTION OF THE EMBODIMENTS

Hereinafter, embodiments are described in detail with reference to the drawings. The same reference numerals are used for the same components, and redundant descriptions thereof are omitted.

Items described in the singular herein may be provided in plural, as can be seen, for example, in the drawings. Thus, the description of a single item that is provided in plural should be understood to be applicable to the remaining plurality of items unless context indicates otherwise.

Throughout the specification, when a component is described as “including” or “comprising” a particular element or group of elements, it is to be understood that the component is formed of only the element or the group of elements, or the element or group of elements may be combined with additional elements to form the component, unless the context indicates otherwise.

The term “about” may reflect amounts or sizes that vary only in a small relative manner, and/or in a way that does not significantly alter the operation, functionality, or structure of certain elements.

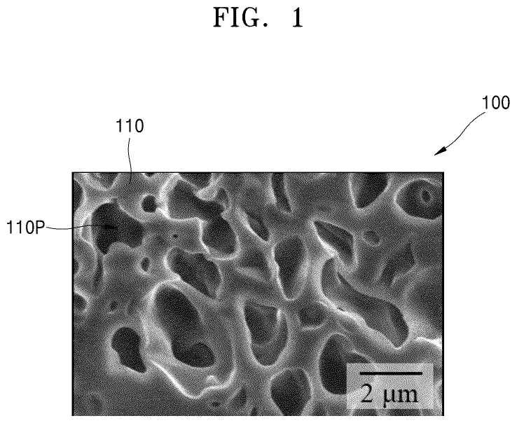

FIG. 1 is an enlarged view of a portion of a wafer cleaning brush 100 according to example embodiments.

Referring to FIG. 1, the wafer cleaning brush 100 may include a body 110. The body 110 may have, e.g., a cylindrical shape. However, the inventive concept is not limited thereto. In another example, the body 110 may include a cylindrical body and a plurality of protrusions disposed on a surface of the cylindrical body.

The body 110 of the wafer cleaning brush 100 may be manufactured using, for example, polyvinyl alcohol (PVA). According to example embodiments, the body 110 of the wafer cleaning brush 100 may include or be polyvinyl formal (PVF) formed by crosslinking PVA to formaldehyde.

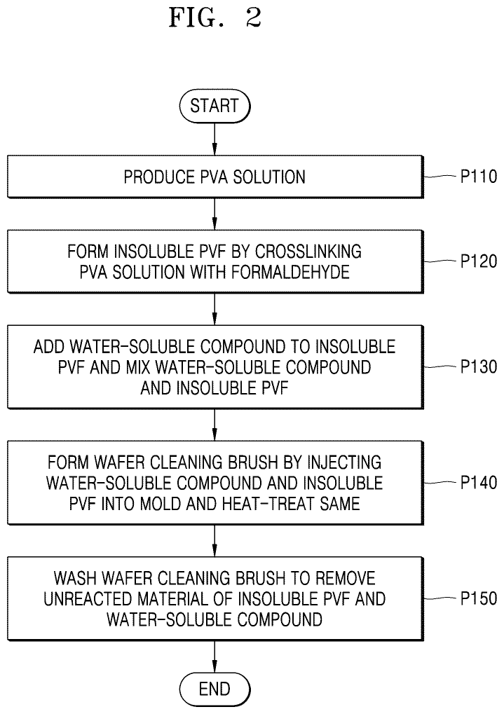

The body 110 of the wafer cleaning brush 100 may have a porous structure having a plurality of pores 110P. When referring to pore size or pore diameter herein, it should be understood that the pore size or pore diameter being referred to is a mean pore size or mean diameter. The term “diameter” is used herein for pores that do not necessarily have a circular or spherical shape, and refers to a largest distance along a straight line between any two edges of the pore, when viewed in a cross-section taken along a particular plane. The “mean pore size” or “mean pore diameter” of a plurality of pores refers to the mean among a group of pores when viewed in one or more cross sections along one or more planes perpendicular to the same direction. The mean pore diameter of the plurality of pores 110P may be from 1 μm to 100 μm. For example, the mean pore diameter of plurality of pores 110P may be from 1 μm to 100 μm, from 10 μm to 80 μm, from 10 μm to 70 μm, or from t 10 μm and 60 μm. The diameter of each pore of the plurality of pores 110P may refer to a maximum diameter of each pore of the plurality of pores 110P. The mean pore diameter refers to a mean pore diameter of the plurality of the pores, with it being understood that individual pore diameters of individual pores may fall outside the range. The mean pore diameter of the plurality of pores 110P formed in the body 110 of the wafer cleaning brush 100, according to embodiments, may be relatively less than a mean diameter of pores of a conventional wafer cleaning brush. This may be because the plurality of pores 110P of the present wafer cleaning brush 100 are made using a water-soluble inorganic compound, as described herein, for example with reference to FIGS. 2, 3, and 4.

The wafer cleaning brush 100, according to embodiments, may have a plurality of pores 110P having a relatively small mean diameter as described herein. Because the plurality of pores 110P of the wafer cleaning brush 100 are relatively small, the probability of contact between fine particles and the wafer cleaning brush 100 may relatively increase. Accordingly, compared to a conventional wafer cleaning brush having pores having a relatively large mean pore diameter, using the present wafer cleaning brush 100 fine particles generated by performing the chemical mechanical polishing process (CMP) on wafers are in relatively good contact with the present wafer cleaning brush 100, thereby efficiently cleaning the fine particles.

FIG. 2 is a flowchart of an example method of manufacturing a wafer cleaning brush (P100), according to example embodiments.

Referring to FIG. 2, a PVA solution constituting the body 110 of the wafer cleaning brush 100 (see FIG. 1) may be first produced (P110) or otherwise provided. The PVA solution may be obtained, for example, by mixing a PVA resin with water and heat-treating the mixture or for example by purchasing a PVA solution. In FIG. 2, the material constituting the body 110 of the wafer cleaning brush 100 (see FIG. 1) is shown as PVA, but the inventive concept is not limited thereto.

In example embodiments, a PVA solution may be a 10 wt % PVA aqueous solution, or a 9 wt % to 11 wt % PVA aqueous solution, that may be obtained for example by stirring PVA resin using water as a solvent on a hot plate at 75-80 degrees Celsius, or more than 75 degrees Celsius, for more than 60 minutes or more than 65 minutes.

As indicated above, in non-limiting example embodiments a “PVA solution” may be a solution that may be prepared or obtained from another source, such as being purchased. A “PVA solution” may include or be for example a PVA solution that may be purchased or prepared.

After P110 process is performed, insoluble PVF may be formed by inserting or injecting formaldehyde into the prepared PVA solution and crosslinking PVA solution with formaldehyde (P120). For example 36 wt % to 40 wt %, or 37 wt % to 39 wt % or 38 wt % of formaldehyde may be inserted or injected into the PVA aqueous solution and stirred for 10 minutes (or 8-12 minutes or 9-11 minutes)

In P120 process, the crosslinking may be performed using a catalyst. In some embodiments, the catalyst may include or be a sulfuric acid catalyst. In example embodiments 38 wt % to 42 wt %, or 39 wt % to 41 wt %, or 40 wt % sulfuric acid aqueous solution may be used as a catalyst and added to promote cross-linking through the acetalization reaction of PVA. For example, a mass ratio is PVA aqueous solution:38 wt % formaldehyde:40 wt % sulfuric acid aqueous solution=5:1:1. In P120 process, the crosslinking rate may be controlled by controlling the weight of the catalyst. For example, the crosslinking rate may decrease as the weight of the catalyst decreases.

After P120 process is performed, a water-soluble compound may be added to the insoluble PVF formed in P120 process, and the water-soluble compound and the insoluble PVF may be mixed (P130) to form a mixture of the water-soluble inorganic compound and the insoluble PVF. Through P130 process, the water-soluble compound may be dispersed in the insoluble PVF.

In some embodiments, the water-soluble compound may include or be a water-soluble inorganic compound. The water-soluble inorganic compound may include, for example, NaCl, CaCO₃, or MgSO₄, or a combination thereof, but the inventive concept is not limited thereto. In example embodiments, the water soluble compound may be 28 to 32 wt % of the mixture or 29 to 31 wt % of the mixture or 30 wt % of the mixture.

In P130 process, a ratio of the weight of the water-soluble compound to the weight of the insoluble PVF may be adjusted as needed. For example, the ratio of the weight of the water-soluble compound to the weight of the insoluble PVF may be adjusted according to a target porosity of the wafer cleaning brush 100 (see FIG. 1) prepared by performing P100 process. When the target porosity of the wafer cleaning brush 100 (see FIG. 1) is relatively high, the ratio of the weight of the water-soluble compound to the weight of the insoluble PVF may relatively increase (i.e., the weight of the added water-soluble compound increases). When the target porosity of the wafer cleaning brush 100 (see FIG. 1) is relatively low, the ratio of the weight of the water-soluble compound to the weight of the insoluble PVF may relatively decrease (i.e., the weight of the added water-soluble compound decreases). By adjusting the weight of the water-soluble compound added to P130 process, the wafer cleaning brush 100 (see FIG. 1) having various porosities may be prepared as needed.

In P130 process, the size of the water-soluble compound may be adjusted as needed. The size of the water-soluble compound may refer to a maximum diameter of the water-soluble compound. A water-soluble compound may be formed of particles have different particle sizes with different maximum diameters. If individual compounds or particles of the water-soluble compounds each have a maximum diameter, the “maximum diameter” or the size of the water-soluble compound may refer to a mean of the individual compound maximum diameters. For example, the size (such as a mean size) of the water-soluble compound or particles thereof may be adjusted according to the target pore size (pore diameter) of the wafer cleaning brush 100 (see FIG. 1) prepared by performing P100 process. When the target mean pore size of the wafer cleaning brush 100 (see FIG. 1) is relatively large, the mean size of the water-soluble compound may relatively increase. When the target mean pore size of the wafer cleaning brush 100 (see FIG. 1) is relatively small, the mean size of the water-soluble compound may relatively decrease. A maximum diameter of individual particles of water soluble compound may be larger or smaller than the target size.

The size of the water-soluble compound may be adjusted for example through a grinding process, e.g., using a grinder. By adjusting the size of the water-soluble compound added to P130 process, the wafer cleaning brush 100 (see FIG. 1) having various pore sizes may be produced as needed.

After P130 process is performed, the wafer cleaning brush 100 (see FIG. 1) may be manufactured by inserting or injecting a mixture of the water-soluble compound and the insoluble PVF into a mold and heat-treating or curing the mixture of the water-soluble compound and the insoluble PVF inserted or injected into the mold (P140). The mold may vary depending on the shape of the wafer cleaning brush 100 (see FIG. 1) to be formed. For example, when the wafer cleaning brush 100 (see FIG. 1) to be formed has a cylindrical shape, the mold may also have a cylindrical shape.

After P140 process is performed, the wafer cleaning brush 100 (see FIG. 1) formed in P140 process may be removed from the mold and washed to remove the water-soluble compound and unreacted material (P150). For example, the unreacted material may include or be PVA solution and formaldehyde that did not react in P120 process. By performing P150 process to remove the water-soluble compound, the plurality of pores 110P (see FIG. 1) may be formed in the space where the water-soluble compound was located. In the method of manufacturing the wafer cleaning brush (P100), because the water-soluble inorganic compound is used, the water-soluble inorganic compound may be completely removed using water in P150 process. The present embodiments are not limited however, and it is contemplated that substances other than water may be used to remove water-soluble inorganic compound.

In a method of manufacturing the conventional wafer cleaning brush, pores were formed using starch. In this case, because the size of the starch reaches several hundred micrometers, the pores formed by removing the starch may not have a fine size of several tens of micrometers or less. Thus, the size of each pore of the plurality of pores is not uniform. In addition, some starch is not removed in the washing process using water and remains in the wafer cleaning brush, considering components of the starch, thereby back-contaminating the wafer in the subsequent wafer cleaning process.

On the other hand, the wafer cleaning brush manufactured according to the method of manufacturing the wafer cleaning brush (P100), according to example embodiments, may form a plurality of pores by mixing the water-soluble compound with the insoluble PVF and removing the water-soluble compound. Because the water-soluble compound is used, the plurality of pores may be formed to a fine size of tens of micrometers or less by adjusting the size of the water-soluble compound. In addition, each pore of the plurality of pores may be formed to have a uniform or relatively uniform size. Relatively uniform may mean for example that at least 80% (or 90% or 95%) of the pores in the plurality of pores has a pore diameter plus/minus 5% (or 10%) of the mean pore size.

In addition, because the water-soluble compound is easily washed with water, the water-soluble compound may not remain in the wafer cleaning brush after washing. Accordingly, even when the wafer on which the CMP process is performed is cleaned using the wafer cleaning brush manufactured according to the method of manufacturing the wafer cleaning brush according to example embodiments, there is no risk of back-contaminating the wafer.

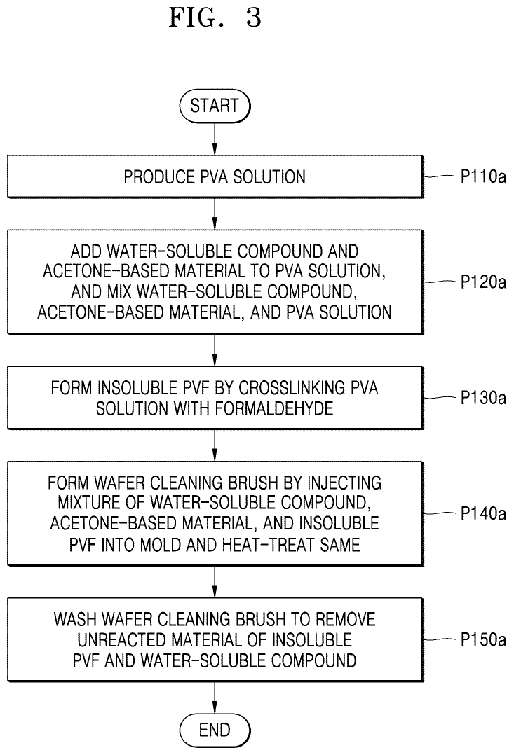

FIG. 3 is a flowchart of another example method of manufacturing a wafer cleaning brush (P100a), according to another embodiment. Because each operation of the method of manufacturing of the wafer cleaning brush (P100a) to be described with reference to FIG. 3 is similar to each operation of the method of manufacturing the wafer cleaning brush (P100) described with reference to FIG. 2, differences are mainly described herein. Similar elements or features or steps to the configurations described herein in FIGS. 1 to 2 may be the same as described in FIGS. 1 to 2.

Referring to FIG. 3, the PVA solution constituting the body of the wafer cleaning brush may be produced (P110a). The PVA solution may be obtained, for example, by mixing PVA resin with water and then heat-treating the mixture.

In example embodiments, a 10 to 15 wt % or 11-14 wt % PVA aqueous solution may be prepared using water as a solvent for PVA resin on a hot plate at 75 degrees Celsius or higher for 60 minutes or longer. A small amount of acetone may be included in or added to the 10-15 wt % PVA aqueous solution.

After P110a process is performed, the water-soluble compound and acetone-based material may be added to the PVA solution prepared in P110a process, and the water-soluble compound, the acetone-based material, and the PVA solution may be mixed (P120a). Through P120a process, the water-soluble compound may be dispersed in the PVA solution.

In some embodiments, the water-soluble compound may include or be a water-soluble inorganic compound. The water-soluble inorganic compound may include or be, for example, NaCl, CaCO₃, or MgSO₄, or a combination thereof, but the inventive concept is not limited thereto.

In P120a process, the ratio of the weight of the water-soluble compound to the weight of the PVA solution may be adjusted as needed. For example, the ratio of the weight of the water-soluble compound to the weight of the PVA solution may be adjusted according to the target porosity of the wafer cleaning brush prepared by performing P100a process. By adjusting the weight of the water-soluble compound added to P120a process, the wafer cleaning brush having various porosities may be prepared as needed.

In example embodiments in which sodium chloride particles are added as the inorganic compound, a non-limiting example mass ratio of PVA aqueous solution and sodium chloride particles may be for example 3:1, or 2.5:1 to 3.5 to 1.

In P120a process, the size of the water-soluble compound may be adjusted as needed. The size of the water-soluble compound may refer to the maximum diameter of the water-soluble compound or particles thereof. For example, if individual particles each have a maximum diameter, the “maximum diameter” may be the mean of the individual particle maximum diameters. For example, the size of the water-soluble compound may be adjusted according to the target pore size (mean pore diameter) of the wafer cleaning brush prepared by performing P100a process. The size of the water-soluble compound may be adjusted through a grinding process, e.g., using a grinder. By adjusting the size of the water-soluble compound added to P120a process, the wafer cleaning brush having various pore sizes may be prepared as needed.

An acetone-based material may be added to the PVA solution together with the water-soluble compound to prevent the viscosity of the mixture of the PVA solution and the water-soluble compound from increasing, which may occur by adding the water-soluble compound before the PVA solution is crosslinked.

After P120a process is performed, the insoluble PVF may be formed by inserting or injecting formaldehyde into the mixture of the water-soluble compound, the acetone-based material, and the PVA, and crosslinking the PVA solution and formaldehyde (P130a). In P130a process, the crosslinking may be performed for example, using a catalyst.

After P130a process is performed, the wafer cleaning brush may be prepared by inserting or injecting the mixture of the water-soluble compound, the acetone-based material, and the insoluble PVF into a mold, and heat-treating the mixture of the water-soluble compound, the acetate-based material, and the insoluble PVF inserted or injected into the mold (P140a). The mold may vary depending on the shape of the wafer cleaning brush to be formed.

After P140a process is performed, the wafer cleaning brush formed in P140a process may be removed from the mold and washed to remove the water-soluble compound, the acetone-based material, and the unreacted material (P150a). The unreacted material may include or be, for example, PVA solution and formaldehyde that did not react in P120a process. By performing P150a process to remove the water-soluble compound, the plurality of pores may be formed in the space where the water-soluble compound was located.

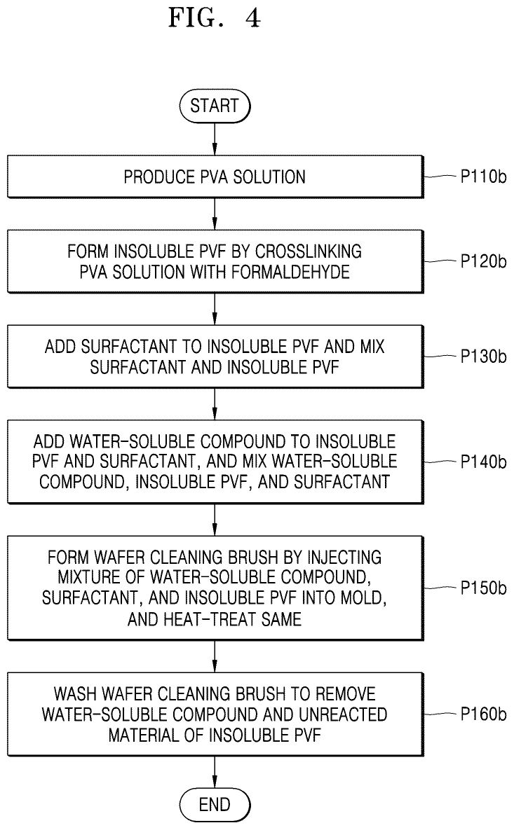

FIG. 4 is a flowchart of a method of manufacturing a wafer cleaning brush (P100b) according to another embodiment. Because each operation of the method of manufacturing the wafer cleaning brush (P100b) to be described with reference to FIG. 4 is similar to each operation of the method of manufacturing the wafer cleaning brush (P100) described with reference to FIG. 2, differences are mainly described herein.

Similar elements or features or steps to the configurations described herein in FIGS. 1 to 3 may be the same as described in FIGS. 1 to 3.

Referring to FIG. 4, the PVA solution constituting the body of the wafer cleaning brush may be first produced (P110b). The PVA solution may be obtained, for example, by mixing PVA resin with water and heat-treating the mixture.

After P110b process is performed, the insoluble PVF may be formed by inserting or injecting formaldehyde into the prepared PVA solution and crosslinking PVA solution with formaldehyde (P120b). In P120b process, the crosslinking may be performed using a catalyst.

After P120b process is performed, a surfactant may be added to the insoluble PVF formed in P120b process (P130b).

The surfactant may include or be, for example, polypropylene glycol (PPG), polyethylene glycol (PEG), or polyacrylamide, or a combination thereof. For example, the surfactant may be octylphenol ethoxylate (e.g. TRITON X-100).

In embodiments having a surfactant, the surfactant, such as TRITON X-100 may be added to the PVA solution for example, at a mass ratio of 14.5:1 to 15.5:1 or 15:1 and stirred.

The surfactant may improve the dispersibility of the water-soluble compound such that the water-soluble compound is better dispersed in the insoluble PVF in P140b process described herein.

After P130b process is performed, a water-soluble compound may be added to the mixture of the insoluble PVF and the surfactant formed in P130b process, and the mixture of the water-soluble compound, the insoluble PVF, and the surfactant may be mixed (P140b). Through P140b process, the water-soluble compound may be dispersed in the insoluble PVF. On the other hand, due to the presence of the surfactant, the dispersibility of the water-soluble compound may be further improved.

In some embodiments, the water-soluble compound may include or be a water-soluble inorganic compound. The water-soluble inorganic compound may include or be, for example, NaCl, CaCO₃, MgSO₄, or a combination thereof, but the inventive concept is not limited thereto.

In P140b process, the ratio of the weight of the water-soluble compound to the weight of the insoluble PVF may be adjusted as needed. For example, the ratio of the weight of the water-soluble compound to the weight of the insoluble PVF may be adjusted according to the target porosity of the wafer cleaning brush prepared by performing P100b process. By adjusting the weight of the water-soluble compound added to P140b process, the wafer cleaning brush having various porosities may be prepared as needed.

In P140b process, the size of the water-soluble compound may be adjusted as needed. The size of the water-soluble compound may refer to the maximum diameter of the water-soluble compound. A water-soluble compound may be formed of particles have different particle sizes with different maximum diameters. If individual water-soluble compounds each have a maximum diameter, the size of the water-soluble compound or particles of the water soluble compound refers to the mean of the individual maximum diameters. The size of the water-soluble compound or particles of the water soluble compound may be adjusted through a grinding process, e.g., using a grinder. By adjusting the size of the water-soluble compound added to P140b process, the wafer cleaning brush having various pore sizes may be prepared as needed.

After P140b process is performed, the wafer cleaning brush may be manufactured (P150b) by inserting or injecting the mixture of the water-soluble compound, the surfactant, and the insoluble PVF into a mold, and heat-treating the mixture of water-soluble compound, the surfactant, and the insoluble PVF inserted or injected into the mold. The mold may vary depending on the shape of the wafer cleaning brush to be formed. For example, when the wafer cleaning brush to be formed has a cylindrical shape, the mold may also have a cylindrical shape.

After P150b process is performed, the wafer cleaning brush formed in P150b process may be removed from the mold and washed to remove the water-soluble compound, the surfactant, and the unreacted material (P160b). The unreacted material may include or be, for example, PVA solution and formaldehyde that did not react in P120b process. By performing P160b process to remove the water-soluble compound, a plurality of pores may be formed in the space where the water-soluble compound was located.

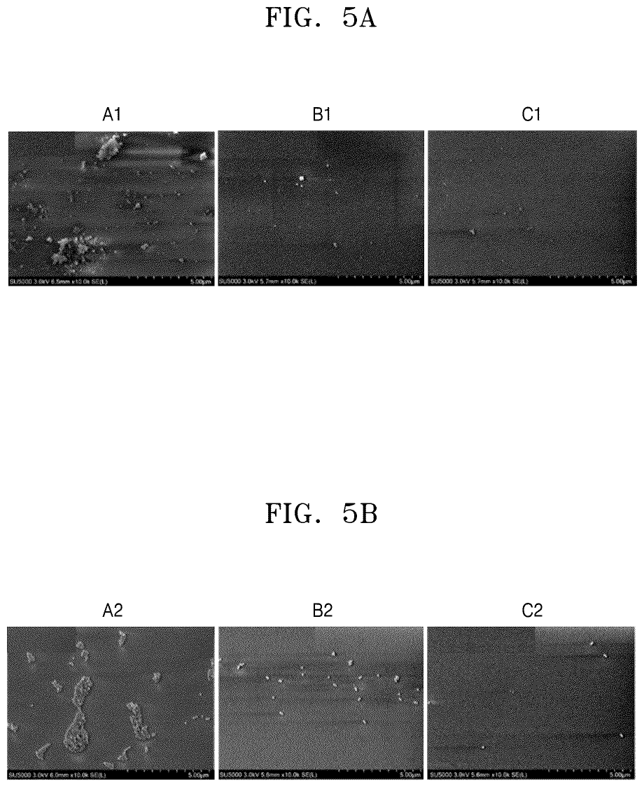

Hereinafter, the method of manufacturing the wafer cleaning brush according to embodiments is described in more detail with reference to FIGS. 5A and 5B and Embodiment A and Embodiment B manufactured by the method of manufacturing the wafer cleaning brush, according to embodiments. Embodiment A and Embodiment B are wafer cleaning brushes manufactured by the method of manufacturing the wafer cleaning brush (P100) described with reference to FIG. 2.

### Embodiment A

The PVA solution of about 10 wt % was prepared by preparing PVA resin and stirring the PVA resin with water as a solvent on a hot plate at 78° C. for 60 minutes.

Next, about 38 wt % of formaldehyde was added to the PVA solution and stirred for about 10 minutes, and then 40 wt % of sulfuric acid solution as a catalyst was added thereto to crosslink the PVA solution with the formaldehyde using an acetalization reaction of PVA. The mass ratio of the PVA solution, the formaldehyde, and the sulfuric acid solution was about 5:1:1.

Next, sodium chloride particles as the water-soluble compound were added to the insoluble PVF formed by the crosslinking and then sufficiently stirred to prepare a mixture of the insoluble PVF and the sodium chloride particles. At this time, a weight ratio of the sodium chloride particles was about 30 wt % based on the total weight of the mixture. The mean diameter of the sodium chloride particles was about 50.2 μm.

Next, the mixture was inserted or injected into a mold, and then cured in an oven at about 65° C. for about 12 hours or more to form a wafer cleaning brush.

Next, the cured wafer cleaning brush was removed from the mold.

Next, the wafer cleaning brush was washed and dehydrated to remove the unreacted material and the sodium chloride particles of the wafer cleaning brush. When the pores of the wafer cleaning brush formed through the above process were measured, the mean diameter of the pores was about 50.2 μm.

### Embodiment B

The PVA solution of about 10 wt %, was prepared by preparing PVA resin and stirring the PVA resin with water as a solvent on a hot plate at 78° C. for 60 minutes.

Next, about 38 wt % of formaldehyde was added to the PVA solution and stirred for about 10 minutes, and then 40 wt % of sulfuric acid solution as a catalyst was added thereto to crosslink the PVA solution with the formaldehyde using the acetalization reaction of PVA. At this time, the mass ratio of PVA solution, formaldehyde, and sulfuric acid solution was about 5:1:1.

Next, sodium chloride particles as the water-soluble compound were added to the insoluble PVF formed by the crosslinking, and then sufficiently stirred to prepare a mixture of the insoluble PV F and the sodium chloride particles. At this time, the weight ratio of the sodium chloride particles was about 30 wt % based on the total weight of the mixture. The sodium chloride particles had a mean diameter of about 12.5 μm.

Next, the mixture was inserted or injected into a mold, and then cured in an oven at about 65° C. for about 12 hours or more to form a wafer cleaning brush.

Next, the cured wafer cleaning brush was removed from the mold.

Next, the wafer cleaning brush was washed and dehydrated to remove the unreacted material and the sodium chloride particles of the wafer cleaning brush. When the pores of the wafer cleaning brush formed through the process were measured, the diameter of the pores was about 12.5 μm.

FIG. 5A depicts images showing the residual amounts of TSO-12 particles before and after a cleaning process using the wafer cleaning brush according to embodiments is performed, and FIG. 5B depicts images showing the residual amounts of COMPOL 80 particles before and after the cleaning process using the wafer cleaning brush is performed according to embodiments. Specifically, FIGS. 5A and 5B are images showing the particles before and after the cleaning process using the wafer cleaning brush of Embodiment A and Embodiment B described above. Specific amounts of particles remaining before and after the cleaning process shown in FIGS. 5A and 5B are shown in Table 1 below.

TABLE 1

| | Embodi- | Embodi- |
|---|---|---|
| | ment A | ment B |
| Average Pore Size | 50.2 | 12.5 |
| TSO-12 Particle Cleaning Efficiency (%) | 96.82 | 99.01 |
| COMPOL 80 Particle Cleaning Efficiency (%) | 96.83 | 97.65 |

In Table 1, TSO-12 particles may refer to fumed silica of Technosemichem, a commercial slurry, and COMPOL 80 particles may refer to colloidal silica of Fujimi, a commercial slurry. The efficiency of cleaning the TSO-12 particles and the efficiency of cleaning the COMPOL 80 particles were obtained by measuring the residual amounts of the TSO12 particles and the COMPOL 80 particles before and after the cleaning process using Embodiment A and Embodiment B, respectively.

Referring to Table 1, in the cleaning process using Embodiment A, it may be seen that the TSO-12 particles are removed with the efficiency of about 96.82% and the COMPOL 80 particles are removed with the efficiency of about 96.83%. In addition, in the cleaning process using Embodiment B, it may be seen that the TSO-12 particles are removed with the efficiency of about 99.01% and the COMPOL 80 particles are removed with the efficiency of about 97.65%.

For example, referring to Table 1, it may be seen that as the diameter of the pores decreases, the particles in the wafer cleaning process are removed more efficiently. Therefore, it may be seen that the cleaning performance of the wafer cleaning brush according to embodiments, manufactured using a water-soluble compound to have pores with a relatively small diameter, is superior to that of the wafer cleaning brush manufactured by the conventional method.

While the inventive concept has been particularly shown and described with reference to embodiments thereof, it will be understood that various changes in form and details may be made therein without departing from the spirit and scope of the following claims.

What is claimed is:

1. A method of manufacturing a wafer cleaning brush, the method comprising:
providing a polyvinyl alcohol (PVA) solution;
forming an insoluble polyvinyl fluoride (PVF) by adding formaldehyde to the PVA solution;
adding a water-soluble inorganic compound comprising a plurality of particles to the insoluble PVF, and mixing the insoluble PVF with the water-soluble inorganic compound to form a mixture of the water-soluble inorganic compound and the insoluble PVF;
forming a wafer cleaning brush by inserting the mixture of the water-soluble inorganic compound and the insoluble PVF into a mold and heat-treating the mixture;
removing the wafer cleaning brush from the mold; and
washing the wafer cleaning brush to remove the plurality of particles of the water-soluble inorganic compound from the wafer cleaning brush.

2. The method of claim 1, wherein the water-soluble inorganic compound comprises at least one compound selected from the group consisting of NaCl, CaCO₃, and MgSO₄.

3. The method of claim 1, wherein a plurality of pores are formed in the wafer cleaning brush in a plurality of spaces from which the plurality of particles of the water-soluble inorganic compound are removed, and a mean pore diameter of the pores is a diameter from 1 μm to 100 μm.

4. The method of claim 1, wherein a plurality of pores are formed in the wafer cleaning brush in a plurality of spaces from which the plurality of particles of the water-soluble inorganic compound are removed, and wherein a mean pore diameter of the plurality of pores is determined based on a diameter of the water-soluble inorganic compound.

5. The method of claim 1, wherein a porosity of the wafer cleaning brush is controlled by controlling a weight of the water-soluble inorganic compound added to the insoluble PVF.

6. The method of claim 1, further comprising adding a surfactant after forming the insoluble PVF and before adding a water-soluble inorganic compound to the insoluble PVF.

7. The method of claim 6, wherein the surfactant comprises oxyphenol ethoxylate.

8. The method of claim 1, wherein the forming of the insoluble PVF is performed by crosslinking using a catalyst.

9. The method of claim 8, wherein a formation rate of the insoluble PVF is adjusted by adjusting a weight of the catalyst.

10. A method of manufacturing a wafer cleaning brush, the method comprising:
providing a polyvinyl alcohol (PVA) solution;
adding a water-soluble inorganic compound comprising a plurality of particles and an acetone-based material to the PVA solution, and mixing the PVA solution, the water-soluble inorganic compound, and the acetone-based material to form a mixture of the PVA solution, the water-soluble inorganic compound, and the acetone-based material;
adding formaldehyde to the mixture of the PVA solution, the water-soluble inorganic compound, and the acetone-based material to form an insoluble polyvinyl fluoride (PVF) and to form a mixture of the water-soluble inorganic compound, the acetone-based material and the insoluble PVF;
forming a wafer cleaning brush by inserting the mixture of the water-soluble inorganic compound, the acetone-based material, and the insoluble PVF into a mold, and heat-treating the mixture;
removing the wafer cleaning brush from the mold; and
washing the wafer cleaning brush to remove the plurality of particles of the water-soluble inorganic compound from the wafer cleaning brush.

11. The method of claim 10, wherein the water-soluble inorganic compound comprises at least one compound selected from the group consisting of NaCl, CaCO₃, and MgSO₄.

12. The method of claim 10, wherein a plurality of pores are formed in the wafer cleaning brush in a plurality of spaces from which the plurality of particles of the water-soluble inorganic compound are removed, and a mean pore diameter of the pores is a diameter from 1 μm to 100 μm.

13. The method of claim 10, wherein a plurality of pores are formed in the wafer cleaning brush in a plurality of spaces from which the plurality of particles of the water-soluble inorganic compound are removed, and wherein a mean pore diameter of the plurality of pores is determined based on a diameter of the water-soluble inorganic compound.

14. The method of claim 10, wherein a porosity of the wafer cleaning brush is determined based on a weight of the water-soluble inorganic compound added to the insoluble PVF.

15. The method of claim 10, wherein the forming of the insoluble PVF is performed by crosslinking using a catalyst.

16. The method of claim 15, wherein a formation rate of the insoluble PVF is determined based on a weight of the catalyst.

17. A method of manufacturing a wafer cleaning brush, the method comprising:
providing a polyvinyl alcohol (PVA) solution;
forming an insoluble polyvinyl fluoride (PVF) by adding formaldehyde and a catalyst to the PVA solution and crosslinking the PVA solution with the formaldehyde by the catalyst;
adding a water-soluble inorganic compound comprising a plurality of particles to the insoluble PVF and mixing the insoluble PVF with the water-soluble inorganic compound to disperse the water-soluble inorganic compound in the insoluble PVF;
forming a wafer cleaning brush by inserting a mixture of the water-soluble inorganic compound and the insoluble PVF into a mold and heat-treating the mixture;
removing the wafer cleaning brush from the mold; and forming a plurality of pores by washing the wafer cleaning brush to remove the plurality of particles of the water-soluble inorganic compound from the wafer cleaning brush.

18. The method of claim 17, wherein the water-soluble inorganic compound comprises at least one compound selected from the group consisting of NaCl, CaCO₃, and MgSO₄.

19. The method of claim 17, wherein a mean pore diameter of the plurality of pores is from 1 μm to 100 μm.

20. The method of claim 18, wherein a mean pore diameter of the plurality of pores is determined based on a mean diameter of the water-soluble inorganic compound, and a porosity of the wafer cleaning brush is determined based on a weight of the water-soluble inorganic compound added to the insoluble PVF.
